(19) United States
(12) Patent Application Publication
(10) Pub. No.: US 2023/0160425 A1
(43) Pub. Date: May 25, 2023

(54) SLIDING MEMBER AND SLIDING BEARING

(71) Applicant: TAIHO KOGYO CO., LTD., Toyota-shi, Aichi (JP)

(72) Inventor: Masaya ICHIKAWA, Toyota-shi (JP)

(73) Assignee: TAIHO KOGYO CO., LTD., Toyota-shi, Aichi (JP)

(21) Appl. No.: 16/325,546

(22) PCT Filed: May 28, 2018
(86) PCT No.: PCT/JP2018/020347

§ 371 Date: Feb. 14, 2019

(30) Foreign Application Priority Data
Jun. 21, 2017 (JP) 2017-121114

(51) Int. Cl. F16C 33/12; F16C 33/14

(52) U.S. Cl. CPC F16C 33/121; F16C 33/14; F16C 2223/70; F16C 2204/36

(57) ABSTRACT

An object of the present invention is to provide a technique capable of realizing good wear resistance with a simple structure. A sliding member and a sliding bearing each include a base layer and a coating layer formed on the base layer, the coating layer having a sliding surface with a counterpart member. The base layer is formed of a hard material that is harder than the coating layer, and the average concentration of a diffusion component of the hard material diffused from the base layer is 4 wt % or more in an evaluation range, in the coating layer, in which the distance from an interface with the base layer is 1 μm or more and 2 μm or less.

### TECHNICAL FIELD

The present invention relates to a sliding member and a sliding bearing in which a counterpart member slides on a sliding surface.

### BACKGROUND ART

Sliding bearings in which 0.3 to 25 vol % of inorganic particles are dispersed in a plating film are known (see Patent Literature 1). In Patent Literature 1, wear resistance can be improved by the inorganic particles contained in the plating film.

### CITATIONS LIST

### Patent Literature

Patent Literature 1: JP H04-331817 A

### SUMMARY OF INVENTION

### Technical Problems

However, there is a problem of technical difficulty in dispersing inorganic particles in a plating film as in Patent Literature 1. Specifically, there is a problem that agglomeration of the inorganic particles occurs and that it is difficult to control the eutectoid rate, at the time of plating. As a result, it is not possible to stably control the dispersion state of the inorganic particles in the plating film and to realize good wear resistance.

The present invention has been made in view of the above-described problems, and an object of the present invention is to provide a technique capable of realizing good wear resistance with a simple structure.

### Solutions to Problems

To achieve the above object, a sliding member and a sliding bearing according to the present invention are a sliding member and a sliding bearing each including a base layer and a coating layer formed on the base layer, the coating layer having a sliding surface with a counterpart member, in which the base layer is formed of a hard material that is harder than the coating layer, and in which the average concentration of a diffusion component of the hard material diffused from the base layer is 4 wt % or more in an evaluation range, in the coating layer, in which the distance from an interface with the base layer is 1 μm or more and 2 μm or less.

In the above structure, the coating layer is formed of a material softer than the hard material for the base layer, but the diffusion component from the base layer diffuses into the coating layer, whereby wear resistance can be improved. Further, by diffusing the hard material from the base layer into the coating layer, it is possible to easily improve the wear resistance. By diffusing the hard material from the base layer into the coating layer, it is possible to maintain the surface side of the coating layer far from the base layer in a soft state, and to obtain good initial conformability. By setting the average concentration of the diffusion component in the evaluation range in which the distance from the interface with the base layer is 1 μm or more and 2 μm or less to 4 wt % or more, good wear resistance can be exhibited at the latest at the stage where wear has progressed to the evaluation range. It is more desirable that the average concentration of the diffusion component in the evaluation range be 8.2 wt % or more.

Here, the coating layer may be formed of Bi, Sn, Pb, In, or Sb. Bi, Sn, Pb, In, and Sb all have low hardness (for example, Mohs' hardness) and are suitable as materials softer than the hard material for the base layer. On the other hand, the hard material for the base layer may be any material as long as it is harder than these materials for the coating layer and can diffuse into the coating layer. The base layer may be formed of a single element metal, an alloy, or a material in which various particles are dispersed in the matrix.

Further, the diffusion component from the base layer may diffuse into the coating layer at least by grain boundary diffusion at the crystal grain boundaries of the coating layer. This strengthens a portion of the sliding surface where the grain boundaries of the crystal grains of the coating layer are exposed, while the flexibility can be maintained at a portion thereof where the portion (intragranular) other than the grain boundaries of the crystal grains of the coating layer is exposed. Therefore, it is possible to achieve both wear resistance and conformability. Incidentally, it suffices that the diffusion component includes at least a component diffused by grain boundary diffusion, and the diffusion component may include an intragranular diffusion component and a grain boundary diffusion component.

Furthermore, in the evaluation range, the standard deviation of the concentration of the diffusion component in a direction parallel to the interface may be 3 wt % or more. When the standard deviation of the concentration of the diffusion component in the direction parallel to the interface between the base layer and the coating layer is 3 wt % or more in this manner, it can be determined that the diffusion of the diffusion component is biased toward the grain boundaries.

### BRIEF DESCRIPTION OF DRAWINGS

FIG. 1 is a perspective view of a sliding member according to an embodiment of the present invention.

FIG. 2 is a schematic cross-sectional view of the sliding member.

FIG. 3 is a graph of the concentration of a diffusion component.

FIG. 4 is a cross-sectional image of the sliding member.

### DETAILED DESCRIPTION OF EMBODIMENTS

Embodiments of the present invention will be described in the following order.

### (1) First Embodiment

(1-1) Structure of Sliding Member:

(1-2) Measurement Method:

(1-3) Method for Manufacturing Sliding Member:

### (2) Other Embodiments

### (1) First Embodiment

(1-1) Structure of Sliding Member:

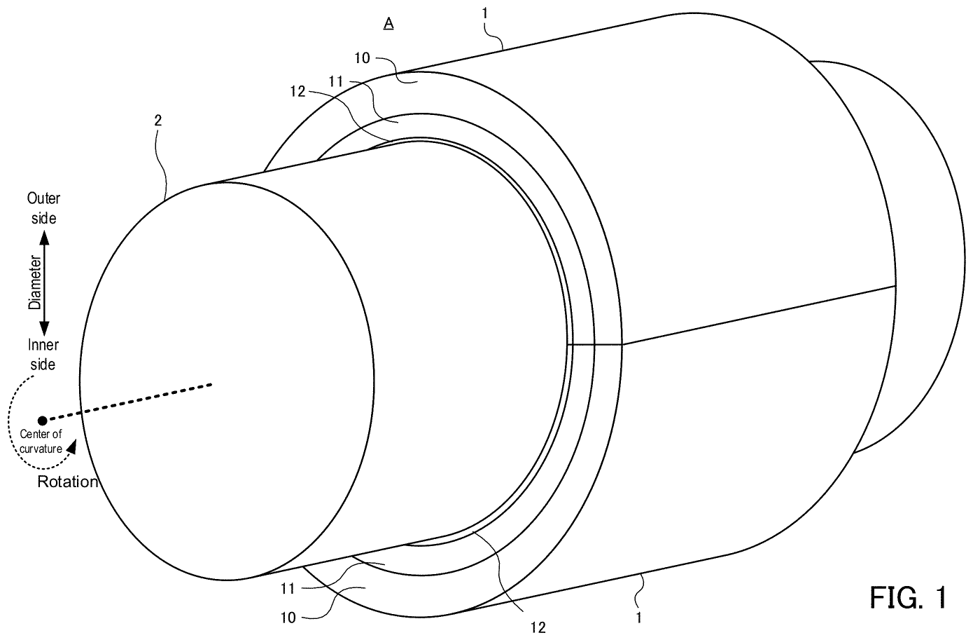

FIG. 1 is a perspective view of a sliding member 1 according to the first embodiment of the present invention. The sliding member 1 includes a back metal 10, a lining 11, and an overlay 12. The sliding member 1 is a half-shaped metallic member obtained by dividing a hollow cylinder into two equal parts in a diametrical direction, and has a semicircular arc shape in cross section. By combining the two sliding members 1 so as to form a cylindrical shape, a sliding bearing A is formed. The sliding bearing A bears a columnar counter shaft 2 (crankshaft of an engine) in a hollow portion formed therein. The outer diameter of the counter shaft 2 is slightly smaller than the inner diameter of the sliding bearing A. A lubricating oil (engine oil) is supplied to a gap formed between the outer peripheral surface of the counter shaft 2 and the inner peripheral surface of the sliding bearing A. At that time, the outer peripheral surface of the counter shaft 2 slides on the inner peripheral surface of the sliding bearing A.

The sliding member 1 has a structure in which the back metal 10, the lining 11, and the overlay 12 are laminated in an order of being distant from the center of curvature. Therefore, the back metal 10 constitutes the outermost layer of the sliding member 1, and the overlay 12 constitutes the innermost layer of the sliding member 1. The back metal 10, the lining 11, and the overlay 12 each have a constant thickness in the circumferential direction. The thickness of the back metal 10 is 1.8 mm, the thickness of the lining 11 is 0.2 mm, and the thickness of the overlay 12 is 10 μm. The diameter of the surface on the curvature center side of the overlay 12 (the inner diameter of the sliding member 1) is 73 mm. Hereinafter, the term “inner side” means the curvature center side of the sliding member 1, and the term “outer side” means the side opposite to the center of curvature of the sliding member 1. The inner surface of the overlay 12 constitutes the sliding surface for the counter shaft 2.

The back metal 10 is formed of steel containing 0.15 wt % of C, 0.06 wt % of Mn, and the balance Fe. It suffices that the back metal 10 is formed of a material that can support the load from the counter shaft 2 via the lining 11 and the overlay 12, and the back metal 10 may not necessarily be formed of steel.

The lining 11 is a layer laminated on the inner side of the back metal 10 and constitutes the base layer of the present invention. The lining 11 contains 10 wt % of Sn, 8 wt % of Bi, and the balance consisting of Cu and unavoidable impurities. The unavoidable impurities of the lining 11 are Mg, Ti, B, Pb, Cr, and the like, and are impurities mixed in refining or scrapping. The content of the unavoidable impurities is 1.0 wt % or less as a whole.

The overlay 12 is a layer laminated on the inner surface of the lining 11, and constitutes the coating layer of the present invention. The overlay 12 is composed of Bi, the diffusion component from the lining 11 and unavoidable impurities, and the content of the unavoidable impurities is 1.0 wt % or less.

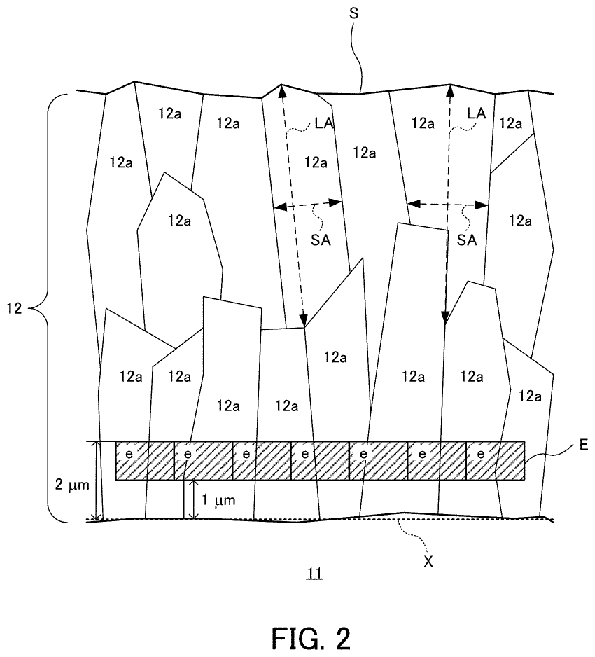

FIG. 2 is a schematic cross-sectional view of the sliding member 1. In this figure, a vertical cross section in the axial direction of the sliding member 1 is shown. The overlay 12 is formed on the lining 11, and a boundary line X (broken line) between the lining 11 and the overlay 12 is linear. Strictly speaking, the boundary line X has an arc shape, but a region sufficiently smaller than the curvature of the sliding member 1 is shown, and the boundary line X is regarded as a straight line. The boundary line X is a line on the interface between the lining 11 and the overlay 12. In FIG. 2, the range sandwiched between a line obtained by moving the boundary line X in parallel to the sliding surface S side by 1 μm and a line by moving the boundary line X in parallel to the sliding surface S side by 2 μm, in the overlay 12, is defined as an evaluation range E. In the present embodiment, the length in the width direction of the evaluation range E was set to 9 μm.

As shown in FIG. 2, crystal grains 12a of the overlay 12 have a columnar shape substantially perpendicular to the boundary line X with the lining 11. Among line segments connecting the two points on the contour line of the single crystal grain 12a, a line segment having the greatest length is defined as a long axis LA, and a line segment on the crystal grain 12a orthogonal to the long axis LA at the midpoint of the long axis LA is defined as a short axis SA. Further, the average value of the ratio obtained by dividing the length of the long axis LA in each of the crystal grains 12a by the short axis SA is defined as an average aspect ratio. The average aspect ratio of the crystal grains 12a was 3. Further, the direction of the long axis LA (the direction approaching the sliding surface S) in each of the crystal grains 12a is defined as a crystal growth direction, and the arithmetic average value in the crystal growth direction in each of the crystal grains 12a is defined as an average crystal growth direction. The average crystal growth direction in this embodiment was substantially perpendicular (85 degrees) to the sliding surface S.

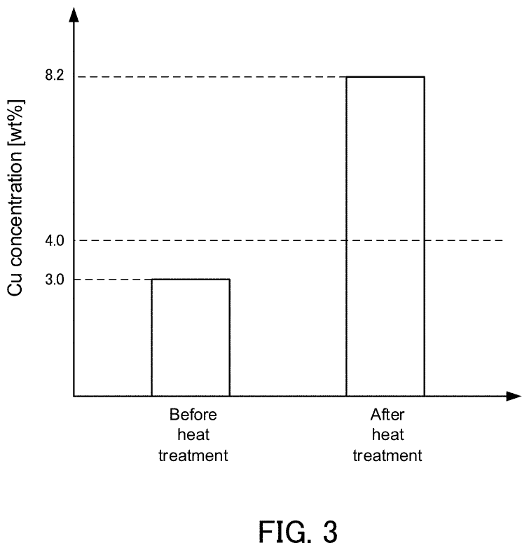

FIG. 3 is a graph showing the average concentration of Cu in the evaluation range E. Cu contained in the overlay 12 is a diffusion component from the lining 11. As shown in FIG. 3, the average concentration of Cu in the evaluation range E was 3.0 wt % before heat treatment which will be described later, whereas the average concentration of Cu in the evaluation range E was 8.2 wt % after the heat treatment which will be described below. In the evaluation range E, Cu of the lining 11 originally diffuses by 3.0 wt %, but the heat treatment increases the concentration of Cu by 5.2 wt %.

In the overlay 12, as the distance from the interface with the lining 11 increases, the concentration of Cu as the diffusion component from the lining 11 decreases. Note that Sn contained in the lining 11 also diffuses into the overlay 12 similarly to Cu.

In FIG. 2, the concentration of Cu was measured for each divided range e obtained by dividing the evaluation range E in the direction of the boundary line X, and the standard deviation of the concentration of Cu for each divided range e was calculated. As a result, the standard deviation of the concentration of Cu per divided range e was 5.6 wt %. The width of each of the divided ranges e in the direction of the boundary line X is the same as the average width of Bi crystal grains in the direction of the boundary line X. The average width of Bi crystal grains is an arithmetic average value of the length of the short axis SA of each of the crystal grains 12a.

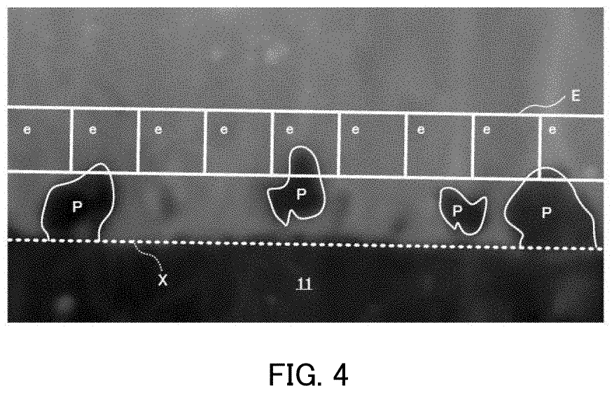

FIG. 4 is a cross-sectional image of the sliding member 1. In the figure, the darker the color (gray) is, the higher the concentration of Cu is. As shown in the figure, there is a protrusion part P having a higher Cu concentration on the overlay 12 side relative to the boundary line X. This protrusion part P is considered to be a portion exposed in the cross section of FIG. 4 in the grain boundary of the crystal grains 12a. That is, in the overlay 12, Cu is diffused in a higher concentration at the grain boundary of the crystal grains 12a than in the crystal grain 12a, and a portion where the grain boundary of the crystal grains 12a is exposed in the cross section of FIG. 4 appears as the protrusion part P. This is also supported by the fact that the standard deviation of the concentration of Cu for each divided range e obtained by dividing the evaluation range E in the direction of the boundary line X is large, i.e., 5.6 wt %.

In the present embodiment described above, the diffusion component from the lining 11 diffuses into the overlay 12, so that the wear resistance can be improved. Further, by diffusing Cu serving as the hard material into the overlay 12 serving as the coating layer from the lining 11 serving as the base layer, it is possible to easily improve the wear resistance. By diffusing Cu into the overlay 12, it is possible to maintain the surface side of the overlay 12 far from the lining 11 in a soft state, and to obtain good initial conformability. Further, by setting the average concentration of the diffusion component (Cu) in the evaluation range E where the distance from the interface between the lining 11 and the overlay 12 is 1 μm or more and 2 μm or less to 8.2 wt %, good wear resistance can be exhibited at the latest at the stage where wear has progressed to the evaluation range E. The present inventor has confirmed that, by managing the average concentration of the diffusion component in the evaluation range E in which the distance from the interface between the lining 11 and the overlay 12 is 1 μm or more and 2 μm or less to be 4 wt % or more, the wear resistance is improved as compared with the case where the average concentration of the diffusion component is less than 4 wt %.

Further, the diffusion component from the lining 11 is diffused in the overlay 12 by grain boundary diffusion. This strengthens a portion of the sliding surface S where the grain boundaries of the crystal grains 12a of the overlay 12 are exposed, while the flexibility can be maintained at a portion thereof where the portion (intragranular) other than the grain boundaries of the crystal grains 12a is exposed. Therefore, it is possible to achieve both wear resistance and conformability. Furthermore, in the evaluation range E, the standard deviation of the concentration of the diffusion component in the direction parallel to the interface between the lining 11 and the overlay 12 is 5.6 wt % which is 3 wt % or more. When the standard deviation of the concentration of the diffusion component in the direction parallel to the interface is 3 wt % or more in this manner, it can be determined that the diffusion of the diffusion component is biased toward the grain boundary, of grain boundary diffusion and intragranular diffusion. The present inventor has confirmed that, by managing the standard deviation of the concentration of the diffusion component in the direction parallel to the interface between the lining 11 and the overlay 12 to be 3 wt % or more, the conformability is improved as compared with the case where the standard deviation of the concentration of the diffusion component is less than 3 wt %.

(1-2) Measurement method:

Each of the numerical values shown in the above embodiment was measured by the following method. The mass of the element constituting each of the layers of the sliding member 1 was measured by an ICP emission spectroscopic analyzer (ICPS-8100 manufactured by Shimadzu Corporation).

The thickness of each of the layers was measured by the following procedures. First, the vertical cross section in the axial direction of the sliding member 1 was polished with a cross section polisher (IB-09010CP manufactured by JEOL Ltd.). Image data of an observation image (backscattered electron image) was obtained by photographing the cross section of the sliding member 1 with an electron microscope (JSM-6610A manufactured by JEOL Ltd.) at a magnification of 7000 times. Then, the film thickness was measured by analyzing the observation image with an image analyzer (Luzex AP manufactured by NIRECO).

Further, an analysis image was obtained by photographing the cross section of the sliding member 1 with the electron microscope (JSM-6610A manufactured by JEOL Ltd.) at a magnification of 15000 times. Then, the analysis image was analyzed by the image analyzer (Luzex AP manufactured by NIRECO). Specifically, the average line of the waviness curve (JIS B 0601) forming the interface between the lining 11 and the overlay 12 was specified as the boundary line X by the image analyzer. Further, the grain boundaries of the respective crystal grains 12a in the overlay 12 were detected by the image analyzer, and the long axis LA, the short axis SA, and the crystal growth direction of each of the crystal grains 12a were specified. The grain boundaries of the respective crystal grains 12a can be detected by edge detection, for example. Further, the average value of the ratio obtained by dividing the length of the long axis LA in each of the crystal grains 12a by the short axis SA was calculated as the average aspect ratio. Note that the crystal grains 12a having a circle equivalent diameter of less than 0.1 μm were excluded from the target for calculation of the aspect ratio.

Further, the concentration of Cu in the evaluation range E in FIG. 2 was measured as follows. Specifically, the cross section of the sliding member 1 polished with the above cross section polisher was analyzed by an element analyzer (EDS (energy dispersive X-ray spectrometer) of JSM-6610A manufactured by JEOL Ltd.) to measure the concentration of Cu in the evaluation range E.

(1-3) Method for Manufacturing Sliding Member:

First, a flat plate of low carbon steel having the same thickness as the back metal 10 was prepared.

Next, powder of a material constituting the lining 11 was scattered on the flat plate formed of low carbon steel. Specifically, Cu powder, Bi powder, and Sn powder were scattered on the flat plate of low carbon steel so as to attain the mass ratio among the respective components in the lining 11 described above. It suffices that the mass ratio among the respective components in the lining 11 can be satisfied, and alloy powder such as Cu—Bi or Cu—Sn may be scattered on the flat plate of low carbon steel. The particle sizes of the powders were adjusted to 150 μm or less by a test sieve (JIS Z 8801).

Next, the flat plate of low carbon steel and the powders sprayed on the flat plate were sintered. The sintering temperature was controlled to 700 to 1000° C., and the sintering was performed in an inert atmosphere. After the sintering, the sintered flat plate was cooled. The lining 11 is not necessarily formed by sintering, and may be formed by casting or the like.

After completion of the cooling, a Cu alloy layer is formed on the flat plate of the low carbon steel. The Cu alloy layer contains soft Bi particles precipitated during the cooling.

Next, the low carbon steel having a Cu alloy layer formed thereon was pressed so as to have a shape obtained by dividing a hollow cylinder into two equal parts in diameter. At this time, the pressing process was performed so that the outer diameter of the low carbon steel matched with the outer diameter of the sliding member 1.

Next, the surface of the Cu alloy layer formed on the back metal 10 was cut. At this time, the cutting amount was controlled so that the thickness of the Cu alloy layer formed on the back metal 10 was the same as that of the lining 11. Thereby, the lining 11 can be formed by the Cu alloy layer after the cutting process. The cutting process was carried out by a lathe with a cutting tool material made, for example, of sintered diamond set. The surface of the lining 11 after the cutting process constitutes the interface between the lining 11 and the overlay 12.

Next, Bi was laminated to a thickness of 10 μm on the surface of the lining 11 by electroplating, whereby the overlay 12 was formed. The electroplating procedures were as follows. First, the surface of the lining 11 was washed with water. Further, unnecessary oxides were removed from the surface of the lining 11 by pickling the surface of the lining 11. Thereafter, the surface of the lining 11 was again washed with water.

Upon completion of the above pretreatment, electroplating was performed by supplying a current to the lining 11 immersed in a plating bath. A bath composition of the plating bath containing methane sulfonic acid: 50 to 250 g/l, methane sulfonic acid Bi: 5 to 40 g/l (Bi concentration), and a surfactant: 0.5 to 50 g/l. The bath temperature of the plating bath was set to 20 to 50° C. Further, the current supplied to the lining 11 was a direct current, and the current density was set to 0.5 to 7.5 A/dm². In the electroplating, the plating bath (liquid) was put in a stationary state without liquid flow. As a result, the crystal grains 12a can be crystal-grown from the surface of the lining 11 toward the center of curvature. After completion of the electroplating, water washing and drying were carried out.

Next, the components (mainly, Cu) of the lining 11 were diffused into the overlay 12 by heat treatment for 50 hours in a state where the temperature was maintained at 150° C. As a result, as shown in the graph of FIG. 3, the concentration of the diffusion component from the lining 11 in the evaluation range E could be increased after the heat treatment. The temperature of the heat treatment is desirably 65% or less of the melting point of the element to be diffused, and is desirably 175° C. or less when the element to be diffused is Bi. This makes it possible to prevent the components of the lining 11 from diffusing into the Bi crystal grains 12a and to diffuse the components of the lining 11 at the grain boundaries of the Bi crystal grains 12a.

When the sliding member 1 was completed as described above, the sliding bearing A was formed by combining the two sliding members 1 in a cylindrical shape.

### (2) Other Embodiments

In the above embodiment, the sliding member 1 constituting the sliding bearing A for bearing the crankshaft of the engine has been illustrated, but sliding bearings A for other purposes may be formed by the sliding member 1 of the present invention. For example, a radial bearing such as a transmission gear bush or a piston pin bush/boss bush may be formed by the sliding member 1 of the present invention. Furthermore, the sliding member of the present invention may be a thrust bearing, various washers, or a swash plate for a car air-conditioner compressor. Further, the matrix of the lining 11 is not limited to the Cu alloy, and it suffices that the material of the matrix is selected according to the hardness of the counter shaft 2. It suffices that the material for the coating layer is softer than the lining 11, and the material for the coating layer may be, for example, any of Pb, Sn, In, and Sb.

### REFERENCE SIGNS LIST

1 Sliding member
2 Counter shaft
10 Back metal
11 Lining
12 Overlay
12a Crystal grain
A Bearing
E Evaluation range
LA Long axis
P Protrusion part
S Sliding surface
SA Short axis
X Boundary line
E Divided range

1. A sliding member comprising a base layer and a coating layer formed on the base layer, the coating layer having a sliding surface with a counterpart member,
wherein the base layer is formed of a hard material that is harder than the coating layer, and
wherein an average concentration of a diffusion component of the hard material diffused from the base layer is 4 wt % or more in an evaluation range, in the coating layer, in which the distance from an interface with the base layer is 1 μm or more and 2 μm or less.

2. The sliding member according to claim 1, wherein the diffusion component diffuses into the coating layer at least by grain boundary diffusion at crystal grain boundaries of the coating layer.

3. The sliding member according to claim 2, wherein a standard deviation of a concentration of the diffusion component in a direction parallel to the interface in the coating layer is 3 wt % or more.

4. A sliding bearing comprising a base layer and a coating layer formed on the base layer, the coating layer having a sliding surface with a counterpart member,
wherein the base layer is formed of a hard material that is harder than the coating layer, and
wherein the average concentration of a diffusion component of the hard material diffused from the base layer is 4 wt % or more in an evaluation range, in the coating layer, in which the distance from an interface with the base layer is 1 μm or more and 2 μm or less.

5. The sliding bearing according to claim 4, wherein the diffusion component diffuses into the coating layer at least by grain boundary diffusion at crystal grain boundaries of the coating layer.

6. The sliding bearing according to claim 5, wherein the standard deviation of the concentration of the diffusion component in a direction parallel to the interface in the coating layer is 3 wt % or more.
